(19) United States
(12) Patent Application Publication
(10) Pub. No.: US 2009/0117953 A1
(43) Pub. Date: May 7, 2009

(54) CONSTRUCTION OF MOBILE DEVICE

(76) Inventor: Jun-Soo Oh, Seoul (KR)

Correspondence Address: John W. Renner;RENNER, OTTO, BOISSELLE & SKLAR, 1621 Euclid Avenue, 19th Floor, Cleveland, OH, 44115, US

(21) Appl. No.: 12/300,163

(22) PCT Filed: May 10, 2005
(86) PCT No.: PCT/KR07/02314

§ 371 Date: Nov. 10, 2008

(30) Foreign Application Priority Data
May 10, 2006 (KR) 10-2006-0041980
Nov. 23, 2006 (KR) 10-2006-0116441
Feb. 7, 2007 (KR) 10-2007-0012583
May 4, 2007 (KR) 10-2007-0043465

(51) Int. Cl. H04M 1/00

(52) U.S. Cl. 455/575.1

(57) ABSTRACT

Disclosed herein is a construction of a mobile device. The mobile device comprises a display unit 1 to display phone call information and various other kinds of communication information, and a main body to which the display unit is coupled. The display unit comprises display windows disposed on front and rear sides of the display unit with a circuit board interposed therebetween, and sliders protruding from both sides at a leading end of the display unit in a longitudinal direction. The main body has a bottom wall, and sidewalls extending upwardly from two or three edges of the bottom wall to define a coupling recess at the central region of the main body such that the display unit is seated in and coupled to the coupling recess. Here, the main body is opened at one or two remaining edges of the bottom wall to form an open part(s), and is provided with slide grooves on opposite sidewalls in the longitudinal direction, such that the slides of the display unit are slidably inserted into the slide grooves, and with a battery coupled to the rear of the bottom wall.

### TECHNICAL FIELD

The present invention relates to a construction of a mobile device, and more particularly to a construction of a mobile device that enables movement of a body and a display unit with respect to each other and includes display windows provided to both front and rear sides of the display unit to allow the display unit to be converted forward and backward with respect to the body in use.

### BACKGROUND ART

With development in technology of mobile devices, various constructions of the mobile devices have been suggested along with increasing trends of incorporating various functions such as MP3P, DMB, PDA and the like into a single mobile device having a mobile phone function.

Although the mobile device must have a larger display window to show various kinds of image information in effecting such functions, a conventional mobile device having the mobile phone function has various kinds of functional keys on the same location as that of the display window, and is thus limited in size of the display window. For example, since a conventional personal media player (PMP) has a large-size screen (for example, 4.3″, 4.0″, etc.) that requires greater power consumption than a small-size screen (for example, 2.2″, 2.0″, etc.), it employs an unnecessary “high-power large-size screen” for functions of MP3P, voice call, etc., which causes reduction in operating time.

Therefore, there is a need of a mobile device that enables a low-power small-size screen to be used in effecting general voice call and a MP3P function to extend an operating time and minimize power consumption of a battery, and that also enables use of a high-power large-size screen (for example, 4.3″, 4.0″, etc.) for functions such as PMP, navigator, UMPC, play station, web surfing, E-mail, etc. and use of a low-power small-size screen (for example, 2.2″, 2.0″, etc.) for functions such as a mobile phone, MP3P, text messaging, etc., in views of appearance and functions of the mobile device, thereby improving utility and convenience of the mobile device.

Furthermore, under current circumstances in the market, a consumer separately purchases various kinds of mobile devices, that is, MP3P, DMB, PMP, PDA, PSP, UMPC, navigator, mobile phone etc. according to his or her requirement, which causes waste of money along with environmental contamination and resource waste resulting from disuse of these devices.

### DISCLOSURE OF THE INVENTION

### Technical Problem

Therefore, the present invention is conceived to solve the problems and inconvenience of the conventional techniques as described above, and an object of the present invention is to provide a construction of a mobile device that includes a narrow display window for a mobile phone function and a wide display window for an image display function disposed respectively on opposite sides of a display unit movably coupled to a body of the mobile device, enabling various functions of the mobile device to be effected at the same time while allowing a user to conveniently view information displayed on the display windows.

It is another object of the present invention to provide the construction of the mobile device that incorporates separate functions of conventional mobile devices (for example, MP3P, DMB, PMP, PDA, PSP, UMPC, navigator, mobile phone, etc.) into a single terminal unit such that functions of MP3P, a mobile phone for voice call, etc. can be effected on a front display window, while functions of PlayStation Portable (PSP) for video games, DMB, PMP for reproduction of movies stored in memories, PDA for information display, UMPC, navigator, etc. can be effected on a rear display window by converting the display windows into a desired operating state.

It is yet another object of the present invention to provide the construction of the mobile device that allows the front and rear display windows to be erected by lifting the display unit on a slider to constitute the front and rear display windows for a user to conveniently read information on the display windows at a desired angle, and that allows the display windows to be rotated to the front or rear side by turning the display unit while pushing the slider in one direction with the display unit erected.

### Technical Solution

In accordance with a first aspect of the present invention, the above and other objects of the present invention can be accomplished by the provision of a mobile device that incorporates a personal digital assistant (PDA) having a pocketbook size and designed to enable personal schedule management, memorandum recording, data storage, and data communication through connection with a wireless communication network via the Internet; an MP3 player to download an MP3 file from the Internet, store the MP3 file in an embedded memory of the mobile device and reproduce music of the MP3 file via a reproduction program with a high sound quality audio compression technique based on MPEG, a standard of image compression; a PlayStation Portable (PSP) designed to be connected to a communication network or a digital appliance for video games, or mounting an exclusive emotion engine CPU therein for the video games while the user uses the mobile device; a mobile communication terminal including a display unit and a separate input window capable of displaying phone call information and various other kinds of communication information for voice call and data communication; PMP or UMPC for text messaging, wireless communication-based Internet surfing and e-mailing, and including a keyboard to effect a function of a handheld PC or an electronic dictionary; and a DMB phone to provide high sound quality and high definition broadcast during movement by receiving a program composed of various multi-media signals including sound and images modified and fixed in a digital manner via a satellite or terrestrial transmission at an associated frequency.

In accordance with a second aspect of the present invention, there is provided a construction of a mobile device comprising a display unit to display phone call information and various other kinds of communication information, and a main body coupled to the display unit to support the display unit, wherein the display unit comprises display windows disposed at both front and rear sides of the display unit, and a sliding member provided to either side at a leading end of the display unit in a longitudinal direction, and wherein the main body has a coupling recess defined at a center of the main body such that the display unit is seated in and coupled to the coupling recess, and a sliding member provided to either inner sidewall of the coupling recess and coupled to the sliding member of the display unit such that the sliding member of the display unit can be slidably fitted into the sliding member of the main body.

Preferably, the sliding member of the display unit is a slider protruding from either side at the leading end of the display unit in the longitudinal direction, and the sliding member of the main body is a slide groove formed on either inner sidewall of the coupling recess in the longitudinal direction.

Preferably, the sliding member of the display unit is a slide groove formed on either outer sidewall of the display unit in the longitudinal direction, and the sliding member of the main body is a slider protruding from either inner sidewall of the coupling recess.

Preferably, the display windows are disposed on both front and rear sides of the display unit with a circuit board interposed between the display windows and each of the front and rear sides thereof. Preferably, the coupling recess is opened at one or both sides to form an opening or openings at the one or both sides.

Preferably, the mobile device further comprises functional buttons on the display windows of the display unit, and a battery on a rear side of a bottom wall of the main body.

Preferably, each of the display windows is a touch screen configured to display menus used to select various kinds of information. Preferably, the display windows on the front and rear sides of the display unit are erected by lifting the display unit on the sliders to allow a user to conveniently read information displayed on the display windows at a desired angle.

Preferably, the display windows can be rotated to the front or rear side by turning the display unit while pushing the slider in one direction with the display unit erected.

Preferably, the display window on the front side of the display unit is configured to display information for effecting an inherent function of a mobile phone and a function of an MP3 player enabling download of an MP3 file from the Internet and reproduction of the MP3 file via a reproduction program to listen to the music, and the display window on the rear side of the display unit is configured to display images or information for effecting functions of PlayStation Portable (PSP) for video games, DMB, PMP for reproduction of movies stored in memories, and PDA.

Preferably, each of the display windows is adjustable in a length protruding from the main body and in a preset angle, and is prevented from shaking.

Preferably, the mobile device further comprises a separate secondary-battery pack detachably attached to the main body, and an adsorption type holder for the secondary-battery pack to be detachably attached to a windshield of a vehicle.

### DESCRIPTION OF DRAWINGS

FIG. 1 is an exploded perspective view of a construction of a mobile device according to the present invention;

FIG. 2 is a perspective view of the construction of the mobile device according to the present invention;

FIG. 3 is a cross-sectional view taken along line A-A of FIG. 1, illustrating a display unit of the mobile device according to the present invention;

FIG. 4 is a cross-sectional view taken along line B-B of FIG. 2, illustrating a coupled structure of the display unit and a main body of the mobile device according to the present invention;

FIG. 5 is a side view illustrating one operating example of the construction of the mobile device according to the present invention;

FIG. 6 is a view illustrating one operating example of the construction of the mobile device according to the present invention;

FIG. 7 shows the construction of the mobile device of FIG. 6 adjusted to a predetermined angle;

FIG. 8 is an exploded perspective view of a construction of a mobile device according to another embodiment of the present invention;

FIG. 9 shows a sliding member of the other embodiment of the present invention;

FIG. 10 shows a sliding member of yet another embodiment of the present invention;

FIGS. 11 and 12 show a sliding member of yet another embodiment of the present invention;

FIG. 13 shows a sliding member of yet another embodiment of the present invention;

FIG. 14 shows a sliding member of yet another embodiment of the present invention;

FIG. 15 shows a sliding member of yet another embodiment of the present invention and a guide member to which the sliding member is coupled;

FIGS. 16 and 17 are longitudinal and transverse cross-sectional views of FIG. 15, respectively;

FIGS. 18a to 18c are cross-sectional views, illustrating the sliding member moving and rotating along the guide member;

FIGS. 19 and 20 show a sliding member of yet another embodiment of the present invention; and

FIGS. 21 and 22 show an secondary-battery pack provided to the main body and an adsorption type holder provided to the secondary-battery pack in the construction of the mobile device according to the present invention.

### BEST MODE

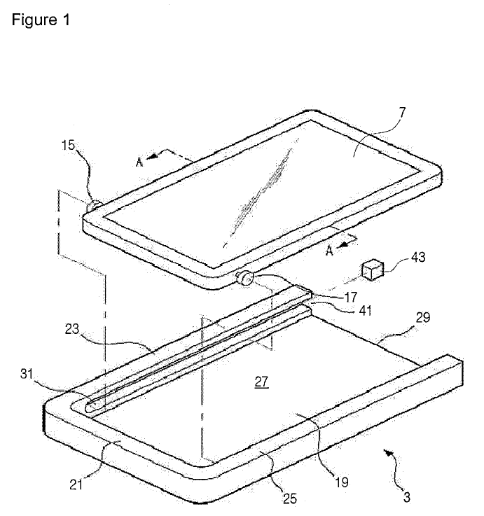

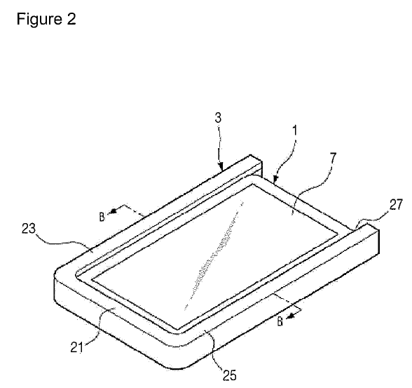

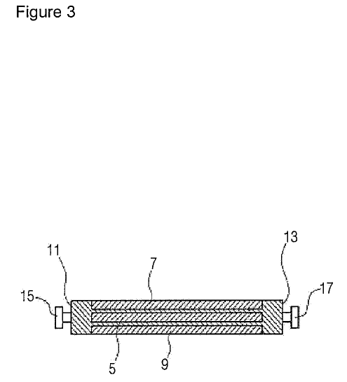

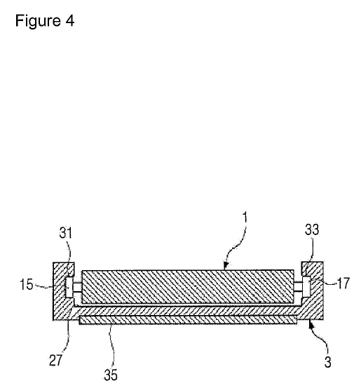

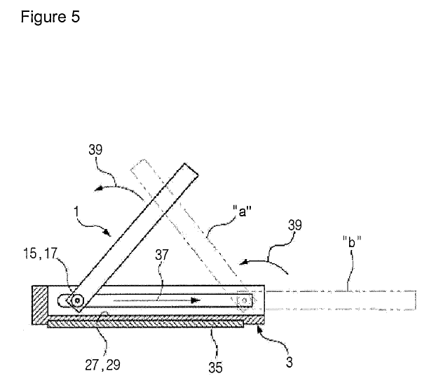

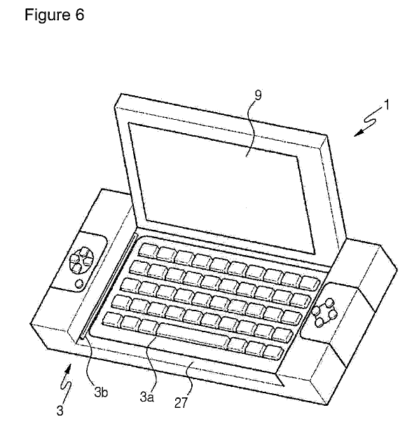

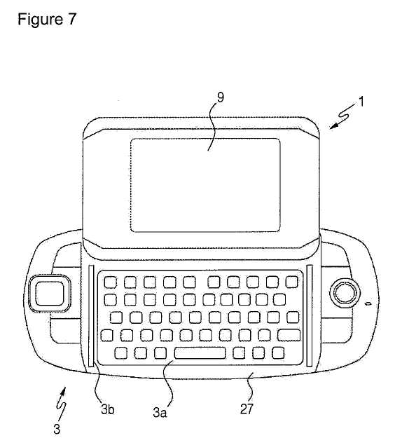

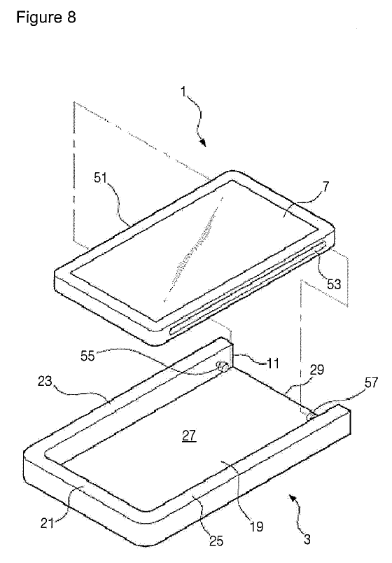

Exemplary embodiments of the invention will be described hereinafter with reference to the accompanying drawings. FIG. 1 is an exploded perspective view of a construction of a mobile device according to the present invention, FIG. 2 is a perspective view of the construction of the mobile device, FIG. 3 is a cross-sectional view taken along line A-A of FIG. 1, illustrating a display unit of the mobile device, FIG. 4 is a cross-sectional view taken along line B-B of FIG. 2, illustrating a coupled structure of the display unit and a main body of the mobile device, FIG. 5 is a side view illustrating one operating example of the construction of the mobile device, FIG. 6 is a view illustrating one operating example of the construction of the mobile device, FIG. 7 shows the construction of the mobile device of FIG. 6 adjusted to a predetermined angle (for example, 30°, 45°, 50°, 60°, 70°, 80°, etc. more than the horizontal angle), and FIG. 8 is an exploded perspective view of a construction of a mobile device according to another embodiment of the present invention.

As shown in these drawings, the construction of the mobile device according to the invention comprises a display unit 1 to display phone call information and various other kinds of communication information, and a main body 3 to which the display unit 1 is coupled and supported thereby.

As shown in the cross-sectional view of FIG. 3, the display unit 1 comprises display windows 7 and 9 disposed on front and rear sides of the display unit 1 with a circuit board 5 interposed between the display windows and each of the front and rear sides thereof, and sliders 15 and 17 protruding from both sides 11 and 13 at a leading end of the display unit 1 in the longitudinal direction.

The main body 3 has a bottom wall 19, and sidewalls 21, 23 and 25 extending upwardly from two or three edges of the bottom wall 19 to define a coupling recess 27 at the central region of the main body 3 such that the display unit 1 can be seated in and coupled to the coupling recess 27. Further, the main body 3 is opened at one or two remaining edges of the bottom wall 19 to form an open part(s) 29, and is provided with slide grooves 31 and 33 on opposite sidewalls 23 and 25 in the longitudinal direction such that the slides 15 and 17 of the display unit 1 are slidably inserted into the slide grooves 31 and 33, and with a battery 35 coupled to the rear of the bottom wall 19.

The sidewall 21 may also have an open structure as in the opening part 29, and in this case, only the sidewalls 23 and 25 will remain.

In this construction of the mobile device, since the display windows 7 and 9 such as LCD are provided to the front and rear sides of the display unit 1, it is possible to selectively use the display windows 7 and 9.

For example, the front display window 7 is configured to display information for effecting an inherent function of a mobile phone, a function of an MP3 player, text messaging, etc., whereas the rear display window 9 is configured to display images or information for effecting functions of DMB, PMP or PDA for reproduction of movies stored in memories, navigator, and UMPC.

Furthermore, the display windows 7 and 9 can be selectively configured as one or more display windows according to applications of those skilled in the art, for example, as a single display window on the front or rear side of the display unit.

Each of the display windows 7 and 9 may be provided with a function key or be constituted by a touch screen on which various menus can be displayed to allow a user to select a desired function.

On the other hand, the sliders 15 and 17 protruding from both sides of the display unit 1 are inserted into the slide grooves 31 and 33 formed on the sidewalls 23 and 25 of the main body 3 to allow the display unit 1 to move up or down. Thus, by bringing the display unit 1 into close contact with the main body 3 with the display window 7 of the front side facing upward to make the display unit 1 and the main body 1 parallel to each other as shown in FIG. 2, the user can obtain information for the inherent function of the mobile phone on the front display window 7.

If necessary, as indicated by a solid line in FIG. 5, by lifting the display unit 1 on both sliders 15 and 17 movably inserted into the slide grooves 31 and 33 formed longitudinally on the opposite inner sidewalls 23 and 25 of the main body 3, the display windows 7 and 9 are erected, allowing the user to conveniently read information displayed on the display window 7 at a desired angle (for example, any angle such as 30°, 60°, 70°, etc. selected by the user).

As such, the front and rear display windows 7 and 9 can be erected at a desired angle by the user, so that the user can conveniently view the display windows 7 and 9.

FIG. 6 shows one operating example of the construction of the mobile device according to the present invention. In this figure, the sliders 15 and 17 can be moved in one direction indicated by arrow 37 of FIG. 5, with the display unit 1 erected or parallel to the main body 3. In one example, when rotating the display unit 1 in a direction of arrow 39 while pushing the sliders 15 and 17 in the direction of the arrow 37 with the display unit 1 erected on the main body 3, the display unit 1 is converted to a position “A” indicated by a dotted line to make the rear display window 9 face upward, allowing the user to employ the rear display window 9 facing upward.

Movement of the display unit 1 is not limited to the aforementioned method. In another example, orientations of the front and rear display windows 7 and 9 can be converted by rotating the display unit 1 to stand up after moving the display unit 1 in a horizontal state in a direction of the arrow 37 to separate from the main body 3 through the open part 29 of the main body 3 as indicated by dotted line “B” of FIG. 5 or after moving the display unit 1 until its movement can be blocked by blocking members 43 disposed at one end of the main body 3. In other words, as shown in FIGS. 6 and 7, the display windows 7(not shown in the Figs.) and 9 on the front and rear sides of the display unit 1 can be adjusted to a desired angle in the direction of the arrow by the method described above.

Furthermore, the coupling recess 27 of the main body 3 may be provided with an operating unit 3a to operate various functions of the mobile device, and with a protrusion 3b spaced from the operating part 3a at an edge of the coupling recess 27 and also minutely spaced from a lower surface of the display unit 1 to prevent shaking of the display unit 1 during movement thereof.

The operating unit 3a is a lid type or a sliding type and can be separated from the main body 3. The operating unit 3a may be formed at a lower side thereof with slots (not shown) for replacement, addition, deletion or upgrade of card-shaped modules that have functions of wireless communication, the Internet, mobile phone, play station, DMB, PMP, PDA, UMPC, electronic dictionary, navigator, etc.

Additionally, the display windows 7 and 9 can be turned forward or rearward to allow the user to construct the display windows 7 and 9 according to user's desired applications by rotating the display unit 1 in an erected state while pushing the sliders 15 and 17 in one direction or by rotating the display unit after pushing the sliders 15 and 17 in parallel to the main body 3 until the sliders 15 and 17 are blocked by the blocking members 43 in the slide grooves 31 and 33.

On the other hand, in order to enable easy coupling of the sliders 15 and 17 of the display unit 1 to the slide grooves 31 and 33 of the main body 3, leading ends of the slide grooves 31 and 33 are cut off to form opened paths 41, through which the sliders 15 and 17 are inserted into the slide grooves 31 and 33 and into which the blocking members 43 are then fitted and secured, respectively, as shown in FIG. 1. FIG. 8 shows another embodiment of the present invention. In this embodiment, slide grooves 51 and 53 are formed on both sides of the display unit 1 in the longitudinal direction, and sliders 55 and 57 protrude from both inner sidewalls 23 and 25 on the coupling recess 27 of the main body 3 such that the sliders 55 and 57 of the main body 3 are inserted into the slide grooves 51 and 53 of the display unit 1 to allow the display unit 1 to slide on the main body 3.

With such construction as described above, the front display window 7 serves to display phone call information, various other kinds of communication information and an MP3 player used to download an MP3 file from the Internet, store the MP3 file in an embedded memory of the mobile device and reproduce music of the MP3 file via a reproduction program with a high sound quality audio compression technique based on MPEG, a standard of image compression, and can be employed to effect the inherent functions of the mobile phone such as voice call, data communication, and the like.

Further, the rear display window 9 displays information for PlayStation Portable (PSP) to provide a video game, PMP or UMPC having a keyboard to act as a handheld PC function or an electronic dictionary and to effect text messaging, wireless communication Internet surfing and e-mailing, and a personal digital assistant (PDA) having a pocketbook size designed to effect schedule and address management, memorandum recording, data storage, and data communication through connection with a wireless communication network via the Internet, and a DMB phone to provide high sound quality and high definition broadcast during movement by receiving a program composed of various multi-media signals including sound and images modified and fixed in a digital manner via a satellite or terrestrial transmission at an associated frequency.

In the construction of the mobile device as described above, the display windows 7 and 9 can be variably constituted, for example, such that a small-size screen (for example, 2.2″, 2.0″, etc.) of the display window 7 is used to effect the functions of the mobile communication terminal, MP3P, text messaging, etc., and a large-size screen (for example, 4.3″, 4.0″, etc.) of the display window 9 is used to effect the functions of PMP, navigator, UMPC, play station, web surfing, E-mail, etc.

At this time, the size and constitution of the front and rear display windows 7 and 9 can be changed according to selection of those skilled in the art.

Each of the sliders 15 and 17 may be formed with one or more stopping grooves 15a and 17a; 15b and 17b to allow the display unit 1 to move in the horizontal state with respect to the main body 3, to temporarily stop the display unit 1 or to temporarily stop rotation of the sliders 15 and 17 by the blocking members 43 in the slide grooves 31 and 33, in corporation with one or more stoppers 31a and 33a; 31b and 33b provided to both sidewalls 23 and 25.

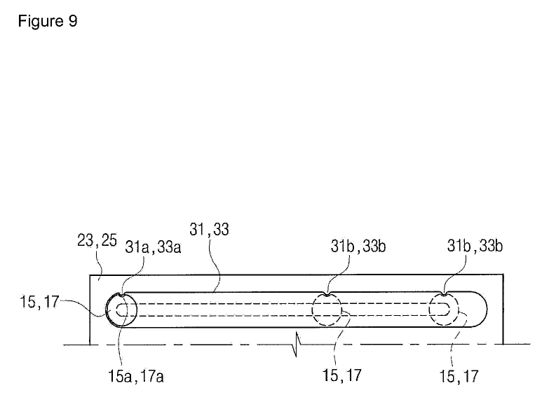

Referring to FIG. 9, in the sliding member according to another embodiment of the invention, at least one stopper 31a or 33a is provided to at least one of upper and lower surfaces of each of the slide grooves 31 and 33 of both sidewalls 23 and 25 where a pair of sliders 15 and 17 is positioned, and at least one stopping groove 15a or 17a corresponding to the stopper 31a or 33a is formed on an outer peripheral surface of each of the sliders 15 and 17 to be positioned in the slide grooves 31 and 33.

Thus, when the stopping grooves 15a and 17a of the sliders 15 and 17 are located on one of the stoppers 31a and 33a, the length of the display unit protruding from the slider groove 31 of the main body 3 is changed by difference in moving distance of the display unit 1. That is, each of the sliders 15 and 17 is provided with one or more stopping grooves 15a and 17a; 15b and 17b, which make it possible to move the main body 3 and the display unit 1 in the horizontal state or to temporarily stop the rotation of the sliders 15 and 17 by the blocking members 43 in the slider grooves 31 and 33.

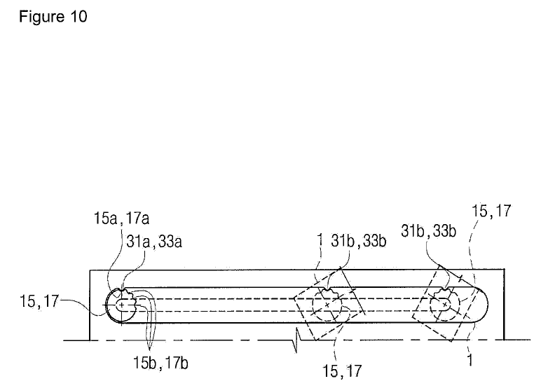

In this embodiment, the stoppers 31a and 33a are illustrated as being on the inner upper surface of the slide grooves 31 and 33. Referring to FIG. 10, according to yet another embodiment, at least one stopper 31b or 33b is formed on at least one of upper and lower surfaces of each slide grooves 31 or 33 as in the above embodiment, and plural stopping grooves 15a and 17a; 15b and 17b corresponding to the stoppers 31a and 33a are formed on an outer peripheral surface of the sliders 15 and 17 to be positioned in the slide grooves 31 and 33.

Here, the stopping grooves 15a and 17a are formed at a location corresponding to the display unit 1 at 0?, and the stopping grooves 15b and 17b are formed to allow the display unit 1 to be rotated at 30°, 45°, 50°, 60°, 70°, 80°, 90°, etc.

Thus, when the stopping grooves 15a and 17a of the sliders 15 and 17 are located on one of the stoppers 31a and 33a, the length of the display unit 1 protruding from the slider groove 31 of the main body 3 is changed by difference in moving distance of the display unit 1 to allow an angle of the display unit 1 to be changed from 0° to 30°, 45°, 50°, 60°, 70°, 80°, 90°, etc. That is, each of the sliders 15 and 17 is provided with one or more stopping grooves 15a and 17a; 15b and 17b, which make it possible to move the main body 3 and the display unit 1 in the horizontal state or to temporarily stop rotation of the sliders 15 and 17 by the blocking members 43 in the slider grooves 31 and 33.

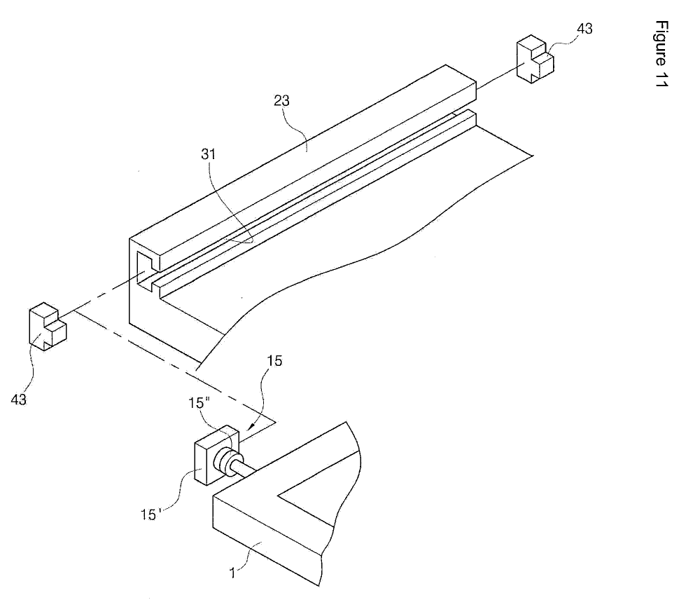

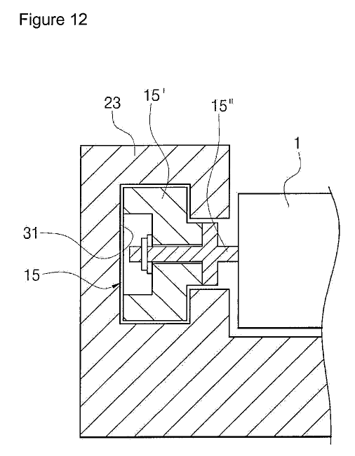

In this embodiment, the stoppers 31a and 33a are illustrated as being on the inner upper surface of the slide grooves 31 and 33. Referring to FIGS. 11 and 12, a slider 15 of a sliding member according to yet another embodiment comprises a rectangular parallelepiped movable block 15′ inserted into the slide groove 31 and making a surface contact at upper and lower surface thereof with the slide groove 31, and a connection member 15″ rotatably coupled to an inner sidewall of the movable block 15′.

Here, when inserted into the slide groove 31, the movable block 15′ of the slider 15 makes the surface contact with the slide groove 31, preventing the display unit 1 from shaking during its movement while allowing rotation of the display unit 1 by the connection member 15″ coupled to the movable block 15′.

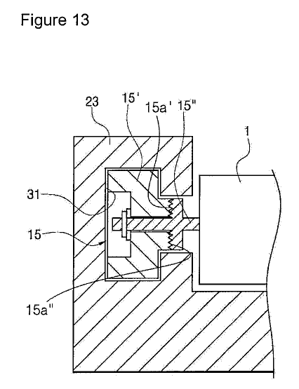

This structure of the slide groove is also applied to the other slider 17 and the other slide groove 33 separated from the slide groove 31. In FIG. 13, teeth (15a′, 15a″) are additionally formed on both contact planes of the movable block 15′ and the connection member 15″ to act as stoppers that enable easy control of the angle of the display unit 1 and prevent the angle of the display unit 1 from being changed due to its weight.

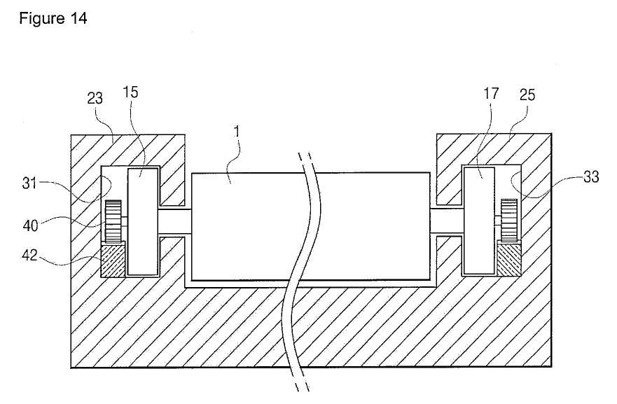

On the other hand, referring to FIG. 14, the construction of the mobile device is configured to allow the display unit 1 to be moved horizontally while preventing stress from being concentrated on the sliders 15 and 17 even when pushing any one end of the display unit 1 other than the center thereof to move the display unit 1.

Specifically, a pinion 40 is disposed inside or outside each slider 15 or 17, and a rack 42 is secured to the bottom of each slide groove 31 or 33 to engage with the pinion 40 to allow horizontal movement of the display unit 1.

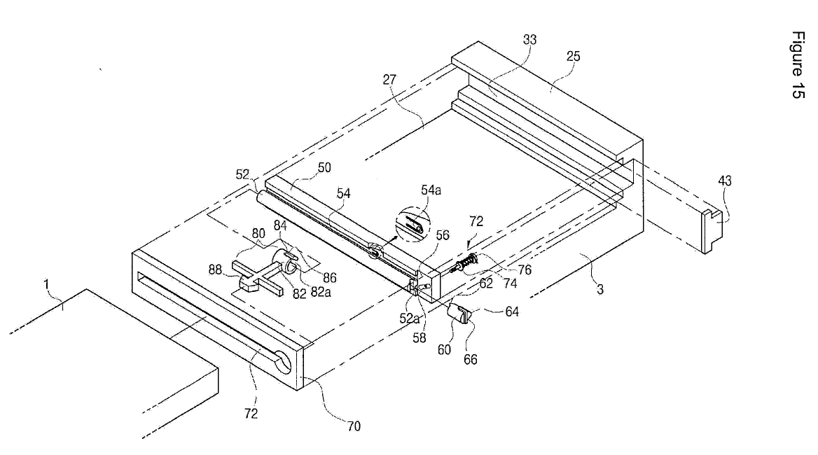

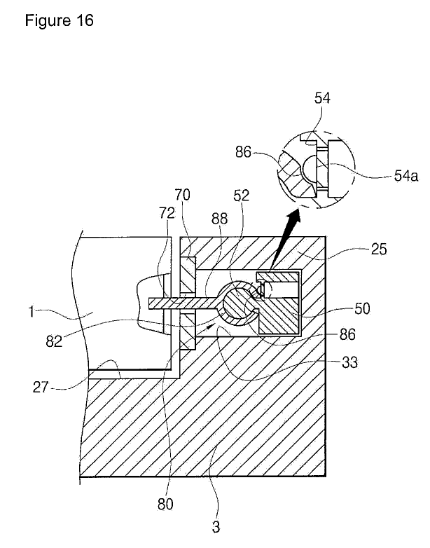

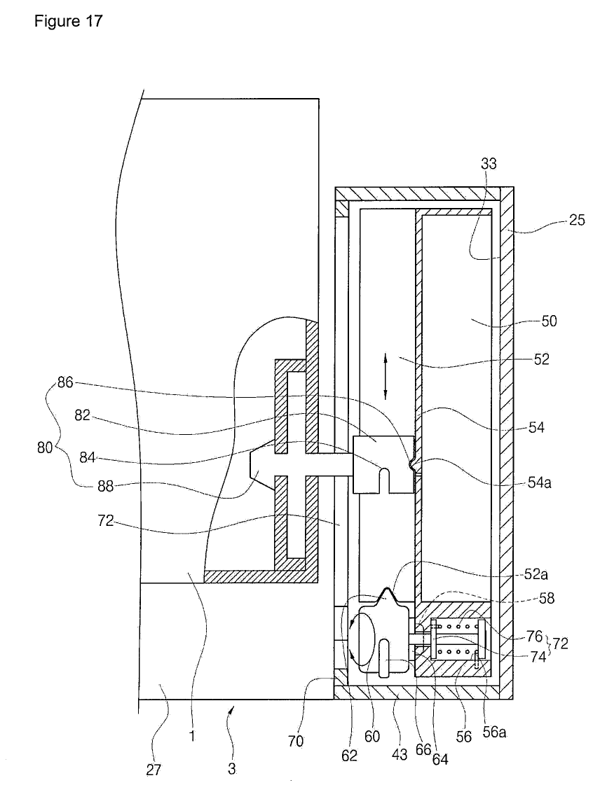

Referring to FIGS. 15 to 17, a sliding member according to yet another embodiment comprises a guide member 50 and a slider 80, and will be described with respect to only one side of the main body 3.

The guide member 50 is a block having a size to be located inside the slide groove 33 formed on the sidewall 25 of the main body 3, and has a cylindrical guide protrusion 52 formed on an inner side of the guide member 50, a slit 54 formed at an upper end of the guide protrusion 52, and an extension part 56 at one side thereof.

Here, with the block member 43 secured to either end of the slide groove 33, the guide member 50 is covered by a cover member 70, which has a movement opening 73 formed on an outer surface of the cover member 70 in a slit shape extending longitudinally and a circular hole formed to face the extension part 56 to allow rotation of the slider 80.

The extension part 56 is provided with a rotational member 60, which can be rotated at a preset angle by movement of the slider 80 connected to the display unit 1, and a restoring part 72 that serves to limit a movement location and a rotational angle.

The guide member 50 is provided with a coupling notch 52a corresponding to a coupling protrusion 62 of the rotational member 60 of the extension part 56.

The extension part 56 is provided with one or more insertion grooves 58 that have a shape corresponding to an insertion protrusion 64 of the rotational member 60 provided in front of the insertion grooves 58 and separately located according to the rotational angle of the display unit 1 to enable the rotational angle of the display unit 1 to be changed, for example, from 0° to 30°, 45°, 50°, 60°, 70°, 80°, 90°, etc. The extension 56 is provided on the rear side with a hole 56a in which the restoring part 72 is inserted.

The slit 54 is provided with one or more latch protrusions 54a, which are spaced irregularly and can cooperate with a latch indentation 86 of the slider 80 to restrict the movement location of the display unit 1 inside the slit 54.

Each of the latch protrusions 54a is formed by cutting a portion of the slit 54 to provide one protruding end capable of moving forward and backward and catching the latch indentation 86 of the slider 80.

The rotational member 60 is formed at one side with the coupling protrusion 62, which can be rotated concentrically with the guide protrusion 52 about the center of the insertion groove 58 of the extension 56 and which can be caught by the coupling notch 52a, at an upper center of the rotational member 60 with a stop protrusion 66 to be caught by a first groove 84 of the slider 80 to restrict a movement location of the slider 80, and at an inner center thereof with the insertion protrusion 64 shaped corresponding to the insertion groove 58 to be inserted into the insertion groove 58 when the insertion protrusion 64 coincides with the insertion groove 58 during rotation.

The restoring part 72 can be rotated at a preset angle when contacts 82 of the sliders 80 secured to both sides of the display unit 1 are located on the rotational member 60, and serves to restore the insertion protrusion 64 to an original location using restoration force in the case where the insertion protrusion 64 is separated from the insertion groove 58 due to external force in the course of inserting the insertion protrusion 64 into the insertion groove 58 by the restoration force when the insertion protrusion 64 coincides with the insertion groove 58.

Specifically, the restoring part 72 has a helical leading end to be fastened to the insertion protrusion 64 of the rotational member 60, and a flange-shaped fixing member 74 integrally formed with the leading end to constitute a middle section of the restoring part 72, providing an integrally rotating bolt shape. Here, the restoring part 72 is provided with a resilient member 76 such as a spring, with one end of the resilient member 76 secured to the fixing member 74 and the other end secured to the hole 56a of the extension part 56, to provide the restoration force for restoring the rotational member 60 to the original location while pulling the rotational member 60 upon twist thereof.

The slider 80 comprises a contact portion 82, which is formed at one end of the slider 80 and has a cylindrical shape corresponding to the guide protrusion 52 of the guide member 50, and a cross-shaped securing portion 88 extending from a rear center of the contact portion 82 and located inside the display unit 1 to be firmly secured to the display unit 1, in which the contact portion includes a cut portion 82a formed at one end of the contact portion 82 collinear with a securing portion 88, the first notch 84 formed at an upper center of the contact portion 82 and connected to an outer wall to be caught by the stop protrusion 66 of the rotational member 60 and the latch indentation 86 formed formed at an upper end of the cut portion 82a to be caught by the latch protrusion 54a of the slit 54.

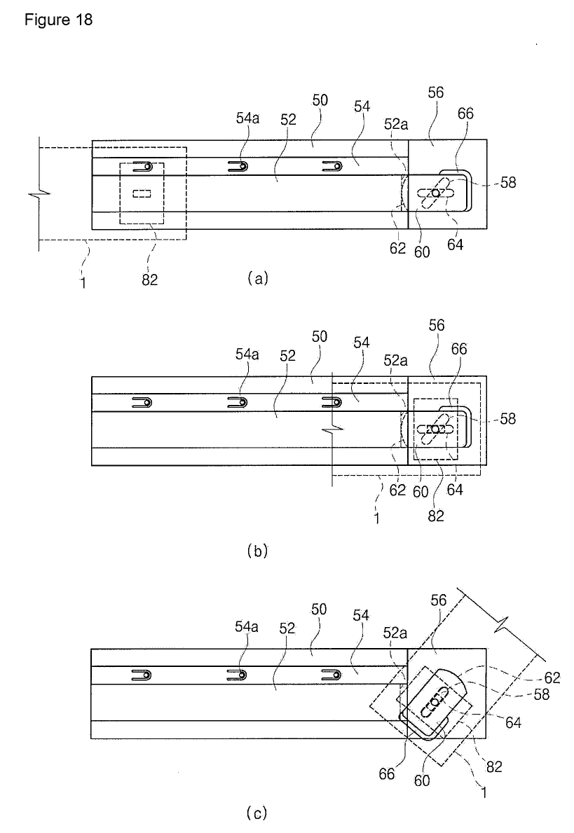

Thus, as shown in FIGS. 18a to 18c, with one end of the slider 80 secured to either side of the display unit 1 via the securing portion 88 and the other end thereof coupled to the guide protrusion 52 of the guide member 50 inside the slider groove 33 through the movement opening 73 of the cover member 70, the slider of this embodiment is moved horizontally and then fixed in its movement location when the latch indentation 86 of the contact portion 82 is located at the one or more latch protrusions 54a on the slit 54.

When the contact portion 82 is located on the rotational member 60 disposed at the leading end of the extension part 56 by further movement of the slider 80, the angle of the display unit 1 can be changed, and the insertion protrusion 64 of the rotational member 60 is inserted into the insertion groove 85 by restoration force of the restoring part 72 as soon as it is changed in its rotational angle so as to correspond to the insertion groove 58 by rotation of the rotational member 60, slider 80 and display unit 1.

Here, when the insertion protrusion 64 of the rotational member 60 is rotated by an angle of the insertion groove 58, the rotational member 60 can be secured in location by the restoration force of the restoring part 72, and in the case of restoring the rotational member 60 to its original location, the rotational member 60 will be located concentrically with the guide protrusion 52 by the resilient member 76 by forcibly deviating the insertion protrusion 64 from the insertion groove 58.

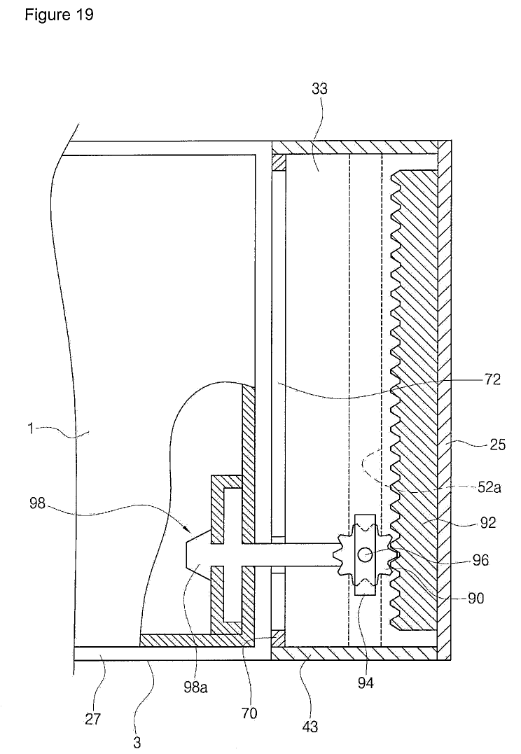

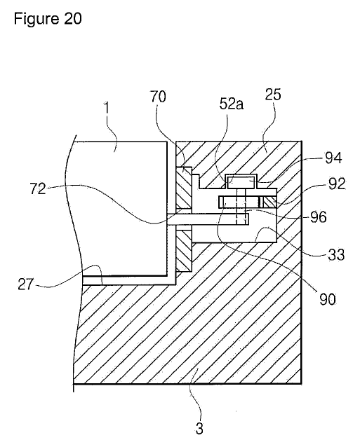

On the other hand, when moving the display unit 1 as shown in FIGS. 19 and 20, it is possible to move the display unit 1 horizontally while preventing stress concentration on sliders 98, one of which will be described hereinafter, only by pushing one end of the display unit 1 other than the center thereof.

Specifically, the slider 98 comprises a cross-shaped securing portion 98a formed at one end of the slider 98 and secured inside the display unit 1, a first pinion 90 secured to the other end by a shaft 98, and a first rack 92 secured to the slide groove 33 of the sidewall 25 and engaging with the first pinion 90 to enable horizontal movement of the display unit 1.

Here, with the securing portion 98a of the slider 98 blocked at either end by the blocking member 43, the first pinion 90 is coupled to the slider 98 through the movement opening 73 of the cover member 70 secured outside the slide groove 33.

Further, a guide block 94 extending in the longitudinal direction is provided on the first pinion 90, and a guide groove 52a is formed longitudinally on the ceiling of the slide groove 33 to allow the guide block 94 to move linearly in the guide groove 52a.

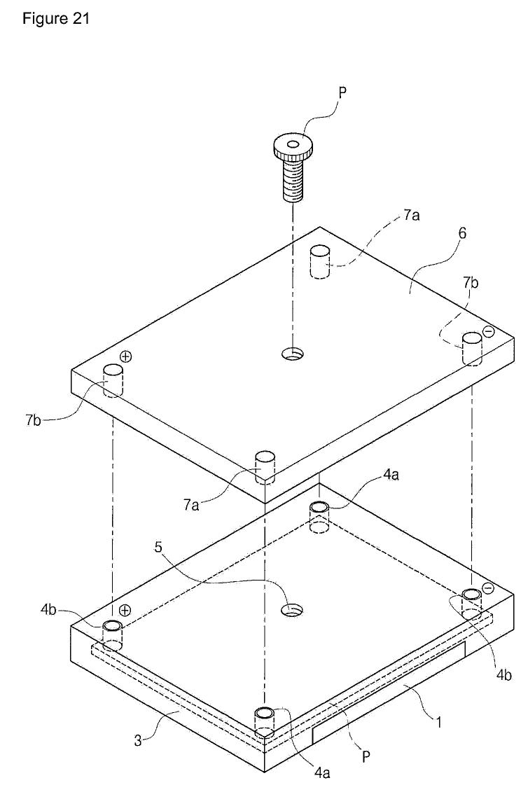

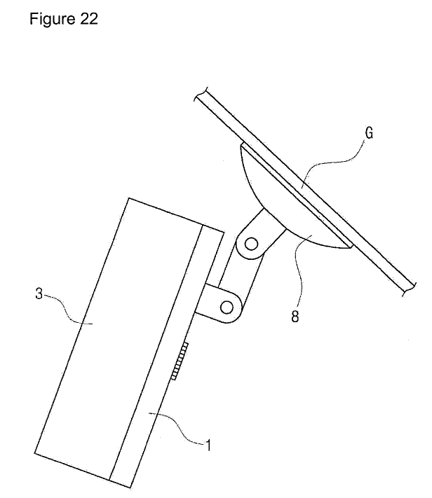

Additionally, as shown in FIGS. 21 and 22, an attachable secondary-battery pack 6 is detachably attached to the rear side of the main body 3.

The secondary-battery pack 6 has male terminals 7a disposed at diagonally opposite ends on the bottom of the secondary-battery pack 6 corresponding to groove-shaped female terminals 4a connected to PCB (P) inside the main body 3 such that the male terminals 7a can be electrically connected to the female terminals 4a, and guide protrusions 7b disposed at diagonally opposite other ends on the bottom corresponding to guide grooves 4b of the main body 3 such that the guide protrusions 7b can be easily coupled to the guide grooves 4b.

As a result, to allow the mobile device to be used without charging for a long time period, the secondary-battery pack 6 is separately provided along with a battery (not shown) inside the main body 3. Here, the secondary-battery pack 6 is coupled to the main body 3 by coupling the male terminals 7a on the bottom of the secondary-battery pack 6 to the female terminals 4a mounted on PCB (P) of the main body 3.

Here, the guide protrusions 7b of the secondary-battery pack 6 can be easily fastened to the guide grooves 4b of the main body 3 when mounting the secondary-battery pack 6 on the main body 3.

In addition, the secondary-battery pack 6 detachably attached to the bottom of the main body 3 is provided with an adsorption type holder 8 to be detachably attached to a windshield G of a vehicle.

Although the preferred embodiments of the present invention have been disclosed for illustrative purposes, those skilled in the art will appreciate that various modifications, additions and substitutions can be made without departing from the scope and spirit of the invention as disclosed in the accompanying claims.

### INDUSTRIAL APPLICABILITY

The construction of the mobile device according to the present invention has display windows disposed on front and rear sides of a display unit for displaying phone call information and various other kinds of communication information, in which the display unit can be movably seated in a coupling recess of a main body by means of sliders protruding from both sides of the display unit to be inserted into slider grooves formed on sidewalls of the main body, so that both the display windows can be conveniently employed as a top screen of the mobile device according to user's selection by standing or turning the display windows with respect to the main body.

In the construction of the mobile device according to the invention, a battery is provided to the main body and a circuit board is provided to the display unit, enabling the display unit to be freely moved while displaying desired information.

Further, by lifting the display unit on the sliders, the front and rear display windows may be stood up, enabling the user to conveniently read and use information displayed on the front or rear display window at a desired angle.

Further, the display windows are configured to be turned toward the front or rear side of the display unit by rotating the display unit while pushing the sliders in one direction after standing the display unit with respect to the main body, maximizing efficiency in use of the mobile device.

Further, according to the invention, the construction of the mobile device enables variable constitution of the display unit according to the user's intention in such a fashion as to allow a low-power small-size screen to be used in effecting general voice call and a MP3P function, so that the mobile device can be used for a long time period and thus enables efficient use of the battery.

Further, according to the invention, the construction of the mobile device enables variable constitution of the display windows in such a fashion as to enable use of a high-power large-size screen (for example, 4.3″, 4.0″, etc.) for functions such as PMP, navigator, UMPC, game machine, web surfing, E-mail, etc., and use of a low-power small-size screen (for example, 2.2″, 2.0″, etc.) for voice call, MP3P, text messaging, etc., in views of appearance and functions of the mobile device, thereby improving utility and convenience of the mobile device.

Further, the construction of the mobile device incorporates functions of various mobile devices such as MP3P, DMB, PMP, PDA, PSP, UMPC, navigator, mobile phone etc. into a single terminal unit such that the functions of MP3P, the mobile phone for voice call, etc. can be effected on the front display window, and the functions of PlayStation Portable (PSP) for video games, DMB, PMP for reproduction of movies stored in memories, PDA for information display, UMPC, navigator, etc. can be effected on the rear display window by converting the display windows into a desired operating state.

Further, according to the invention, each of the display windows can be adjusted in preset angle and length thereof protruding from the main body, and prevented from shaking.

Further, the mobile device further comprises a separate secondary-battery pack detachably attached to the main body, and an adsorption type holder for the secondary-battery pack to be detachably attached to a windshield of a vehicle.

1. A construction of a mobile device comprising a display unit to display phone call information and various other kinds of communication information, and a main body coupled to the display unit to support the display unit,
wherein the display unit comprises display windows disposed at both front and rear sides of the display unit, and a sliding member provided to either side at a leading end of the display unit in a longitudinal direction, and
wherein the main body has a coupling recess defined at a center of the main body such that the display unit is seated in and coupled to the coupling recess, and a sliding member provided to either inner sidewall of the coupling recess and coupled to the sliding member of the display unit such that the sliding member of the display unit can be slidably fitted into the sliding member of the main body.

2. (canceled)

3. The construction of the mobile device according to claim 1, wherein the sliding member is a slide groove formed on either outer sidewall of the display unit in the longitudinal direction, and the sliding member of the main body is a slider protruding from either inner sidewall of the coupling recess.

4. The construction of the mobile device according to claim 1, wherein the display windows are disposed on both front and rear sides of the display unit with a circuit board interposed between the display windows and each of the front and rear sides thereof.

5. (canceled)

6. (canceled)

7. (canceled)

8. The construction of the mobile device according to claim 1, wherein the display windows on the front and rear sides of the display unit are erected by lifting the display unit on the sliders to allow a user to conveniently read information displayed on the display windows at a desired angle.

9. The construction of the mobile device according to claim 8, wherein the display windows can be rotated to the front or rear side by turning the display unit while pushing the slider in one direction with the display unit erected.

10. The construction of the mobile device of any of claims 1, wherein the display window on the front side of the display unit is configured to display information for effecting an inherent function of a mobile phone and a function of an MP3 player enabling download of an MP3 file from the Internet and reproduction of the MP3 file via a reproduction program to listen to the music, and the display window on the rear side of the display unit is configured to display images or information for effecting functions of PlayStation Portable (PSP) for video games, DMB, PMP for reproduction of movies stored in memories, and PDA.

11. The construction of the mobile device according to claim 3 wherein at least one stopper is provided to at least one of upper and lower surfaces of the slide groove, and at least one stopping groove corresponding to the stopper is formed on an outer peripheral surface of the slider to be positioned in the slide groove, such that the display unit coupled to the slider can be longitudinally adjusted in space.

12. The construction of the mobile device according to claim 3, wherein at least one stopper is provided to at least one of upper and lower surfaces of the slide groove, and plural stopping grooves corresponding to the stopper are formed on an outer peripheral surface of the slider to be positioned in the slide groove, such that the display unit coupled to the slider can be longitudinally adjusted in space and angle.

13. The construction of the mobile device according to claim 12, wherein forming angle of the stopping groove is selected from the angle 0°, 30°, 45°, 50°, 60°, 70°, 80°, 90°.

14. The construction of the mobile device according to claim 3, wherein the slider comprises a movable block inserted into the slide groove and making a surface contact at upper and lower surface thereof with the slide groove, and a connection member rotatably coupled to an inner sidewall of the movable block.

15. The construction of the mobile device according to claim 14, wherein teeth are respectively formed on both contact planes of the movable block and the connection member to adjust an angle of the display unit.

16. The construction of the mobile device according to claim 3, wherein the coupling recess is formed at either end with a protrusion parallel to a moving direction of the display unit while being minutely spaced from a surface of the display unit.

17. The construction of the mobile device according to claim 1, wherein the main body is provided with a keyboard-type operating unit used for selection and operation of functions and capable of being opened in a lid type or a sliding type, the operating unit being formed with slots for replacement, addition, deletion or upgrade of the functions.

18. The construction of the mobile device according to claim 3, wherein the slider includes a pinion disposed inside or outside the slider, and, the slide groove includes a rack secured to a bottom of the slide groove to engage with the pinion to allow horizontal movement of the display unit.

19. The construction of the mobile device according to claim 3, wherein the slider is moved along a guide protrusion of a block-shaped guide member, of which leading end is inserted into the slide groove formed on either side of the main body, and comprises a contact portion and a securing portion formed in a cross shape at a rear center of the contact portion and secured to the display unit, the contact portion having a cylindrical shape to be inserted into the guide protrusion, and including a partially cut portion formed at one end of the contact portion, a latch indentation formed at an upper end of the cut portion, and a first notch extending from an end of an upper center of the contact portion.

20. The construction of the mobile device according to claim 19, wherein the guide member comprises:
a cylindrical guide protrusion coupled to the contact portion of the slider and having a coupling groove formed at one side;
one or more insertion grooves formed on a front surface of an extension part extending in an opposite direction to the coupling groove such that the contact portion of the slider is coupled to the insertion grooves when the contact portion of the slider is moved and located on an outer peripheral surface of a rotating member of the extension part, the insertion grooves having different shapes from each other according to a rotating angle of the display unit; and
one or more lath protrusions irregularly spaced on the guide protrusion to restrict a movement location of the display unit in cooperation with the latch indentation of the slider.

21. The construction of the mobile device according to claim 20, wherein the extension part comprises:
a rotational member fastened thereto in an opposite direction to the insertion grooves to allow the slider to be moved and rotated at the same angle as that of the display unit, the rotational member comprising a cylindrical coupling protrusion having the same diameter as that of the guide protrusion and formed at one side of the rotational member corresponding to the coupling groove, a stopping protrusion formed at an upper center of the rotational member corresponding to the first notch to restrict the location of the slider, and an insertion protrusion having a shape corresponding to the insertion groove and formed at one side facing a guide surface inside the rotational member to be inserted into the insertion groove when being rotated at the same angle as that of the insertion groove; and a restoring part fastened to the insertion protrusion of the rotational member through the insertion hole at rear of the extension part, the restoring part comprising a helical leading end fastened to the insertion protrusion and a flange-shaped fixing member formed at a middle portion of the restoring part, and a resilient member having one end secured to the fixing member and the other end secured to the hole of the extension part to provide a restoration force in a horizontal direction to twist.

22. The construction of the mobile device according to claim 3, wherein the slider comprises a cross-shaped portion formed at one end of the slider and secured inside the display unit, a first pinion rotatably provided at the other end, and a first rack secured to the slide groove of the sidewall and engaging with the first pinion to enable horizontal movement of the display unit.

23. The construction of the mobile device according to claim 22, wherein a guide block is secured above the first pinion by a shaft and a guide groove is formed longitudinally on the slide groove to allow movement of the guide block in the guide groove.

24. The construction of the mobile device according to claim 1, further comprising:
a separate secondary-battery pack detachably attached to a rear side of the main body.

25. The construction of the mobile device according to claim 24, wherein the secondary-battery pack has male terminals disposed at diagonally opposite ends on a bottom of the secondary-battery pack corresponding to groove-shaped female terminals connected to PCB inside the main body such that the male terminals can be electrically connected to the female terminals, and guide protrusions disposed at diagonally opposite other ends on the bottom corresponding to guide grooves of the main body such that the guide protrusions can be easily coupled to the guide grooves.

26. The construction of the mobile device according to claim 24, wherein the secondary-battery pack is provided with an adsorption type holder to be detachably attached to a windshield of a vehicle.

27. The construction of the mobile device according to claim 3, wherein the display windows on the front and rear sides of the display unit are erected by lifting the display unit on the sliders to allow a user to conveniently read information displayed on the display windows at a desired angle.

28. The construction of the mobile device according to claim 27, wherein the display windows can be rotated to the front or rear side by turning the display unit while pushing the slider in one direction with the display unit erected.

29. The construction of the mobile device of any of claims 3, wherein the display window on the front side of the display unit is configured to display information for effecting an inherent function of a mobile phone and a function of an MP3 player enabling download of an MP3 file from the Internet and reproduction of the MP3 file via a reproduction program to listen to the music, and the display window on the rear side of the display unit is configured to display images or information for effecting functions of PlayStation Portable (PSP) for video games, DMB, PMP for reproduction of movies stored in memories, and PDA.

30. The construction of the mobile device of any of claims 4, wherein the display window on the front side of the display unit is configured to display information for effecting an inherent function of a mobile phone and a function of an MP3 player enabling download of an MP3 file from the Internet and reproduction of the MP3 file via a reproduction program to listen to the music, and the display window on the rear side of the display unit is configured to display images or information for effecting functions of PlayStation Portable (PSP) for video games, DMB, PMP for reproduction of movies stored in memories, and PDA.
